(19) United States
(12) Patent Application Publication
(10) Pub. No.: US 2021/0034886 A1
(43) Pub. Date: Feb. 4, 2021

(54) SYSTEM AND METHOD FOR PREVENTING SCRAPES ON VEHICLE CARRIAGE

(71) Applicant: Toyota Motor North America, Inc., Plano, TX (US)

(72) Inventors: Blake Murray, Dallas, TX (US); Armin Lange, Addison, TX (US)

(21) Appl. No.: 16/526,675

(22) Filed: Jul. 30, 2019

(51) Int. Cl. G06K 9/00; G08G 1/16; B60W 50/14; B60W 30/08

(52) U.S. Cl. CPC G06K 9/00805; G08G 1/16; B60W 2550/40; B60W 30/08; B60W 2550/147; B60W 50/14

(57) ABSTRACT

Methods and systems for identifying geographic locations where a vehicle carriage of a vehicle may be scraped. The system includes a transceiver of the vehicle configured to receive scraping location data indicating one or more scraping locations, each scraping location being a geographic location where a risk of scraping the vehicle carriage exists. The system also includes a location sensor configured to detect a current location of the vehicle. The system also includes an electronic control unit (ECU) of the vehicle configured to determine whether the vehicle is approaching a scraping location of the one or more scraping locations based on the current location of the vehicle and the scraping location data. The system also includes an input/output device configured to provide a notification that the vehicle is approaching the scraping location of the one or more scraping locations.

### BACKGROUND

### 1. Field

This specification relates to a system and a method for preventing scrapes on a vehicle carriage using big data.

### 2. Description of the Related Art

Vehicles may include a plurality of wheels connected to a vehicle carriage. The plurality of wheels may propel the vehicle, and the vehicle carriage may house any occupants of the vehicle as well as all of the systems required to generate the propulsive force to be translated to the plurality of wheels. When vehicles traverse roads, they may encounter uneven terrain. Driving over uneven terrain may cause the vehicle to dip or be angled relative to a flat surface. When a vehicle dips severely enough, the carriage of the vehicle may make contact with the ground or another surface, such as a curb. This contact with the ground or other surface may be undesirable, as the contact may cause damage to the vehicle carriage. The contact may also make a noise that may be disconcerting for occupants of the vehicle to hear. Thus, there is a need for systems and methods to prevent scrapes to a vehicle carriage.

### SUMMARY

What is described is a system for identifying geographic locations where a vehicle carriage of a vehicle may be scraped. The system includes a transceiver of the vehicle configured to receive scraping location data indicating one or more scraping locations, each scraping location being a geographic location where a risk of scraping the vehicle carriage exists. The system also includes a location sensor configured to detect a current location of the vehicle. The system also includes an electronic control unit (ECU) of the vehicle configured to determine whether the vehicle is approaching a scraping location of the one or more scraping locations based on the current location of the vehicle and the scraping location data. The system also includes an input/output device configured to provide a notification that the vehicle is approaching the scraping location of the one or more scraping locations.

Also described is a vehicle. The vehicle includes a vehicle carriage and wheels. The vehicle also includes a transceiver configured to receive scraping location data indicating one or more scraping locations, each scraping location being a geographic location where a risk of scraping the vehicle carriage exists. The vehicle also includes a location sensor configured to detect a current location. The vehicle also includes an electronic control unit (ECU) configured to determine whether a scraping location of the one or more scraping locations is being approached based on the current location and the scraping location data. The vehicle also includes an input/output device configured to provide a notification that the vehicle is approaching the scraping location of the one or more scraping locations.

Also described is a method for identifying geographic locations where a vehicle carriage of a vehicle may be scraped. The method includes receiving, by a transceiver of the vehicle, scraping location data indicating one or more scraping locations, each scraping location being a geographic location where a risk of scraping the vehicle carriage exists. The method also includes detecting, by a location sensor, a current location of the vehicle. The method also includes determining, by an electronic control unit (ECU) of the vehicle, whether the vehicle is approaching a scraping location of the one or more scraping locations d with vehicles that have under 4 inches of ground clearance. A first vehicle having 3 inches includes providing, by an input/output device, a notification that the vehicle is approaching the scraping location of the one or more scraping locations.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIGS. 1A and 1B illustrate vehicles travelling over roads and scraping the vehicle carriage, according to various embodiments of the invention.

FIG. 2 illustrates a mapping of locations where vehicle carriage scrapes may occur, according to various embodiments of the invention.

FIG. 3 illustrates presentation of warnings to a driver, according to various embodiments of the invention.

FIG. 4 illustrates a block diagram of the system, according to various embodiments of the invention.

FIG. 5 illustrates a process of the system, according to various embodiments of the invention.

FIG. 6 illustrates a process of the system, according to various embodiments of the invention.

### DETAILED DESCRIPTION

Disclosed herein are systems, vehicles, and methods for identifying geographic locations where a vehicle carriage of a vehicle may be scraped. A vehicle carriage may be scraped in any number of situations, such as a dip in the road, an inclined curb leading to a home or business, a front curb in a parking lot, a side curb on a street or a road, or a pole, for example. Scraping of the vehicle carriage may cause damage to the vehicle. In addition, occupants of the vehicle may be alarmed by the scraping noise and sensation. Drivers may be able to reduce or eliminate scraping of the vehicle by slowing down or maneuvering around a road condition that causes the potential scraping.

The systems and methods described herein determine locations where there is a potential for a vehicle to be scraped by collecting vehicle telemetry data from many vehicles and analyzing the vehicle telemetry data. The systems and methods described herein provide locations of the determined locations where there is a potential for a vehicle to be scraped to vehicles so that the vehicles may avoid or prepare for a scraping location. By using the systems and methods described herein, vehicle repairs may be reduced and passenger safety may therefore be increased.

As used herein, “driver” may refer to a human being driving the vehicle when the vehicle is a non-autonomous vehicle, and/or “driver” may also refer to one or more computer processors used to autonomously or semi-autonomously drive the vehicle. “User” may be used to refer to the driver or occupant of the vehicle when the vehicle is a non-autonomous vehicle, and “user” may also be used to refer to an occupant of the vehicle when the vehicle is an autonomous or semi-autonomous vehicle. As used herein, a “scraping location” is a geographic location (as opposed to a location on a vehicle) where a risk of a vehicle carriage of a vehicle being scraped exists. As used herein, a “vehicle carriage” refers to the body of the vehicle and does not include the wheels of the vehicle.

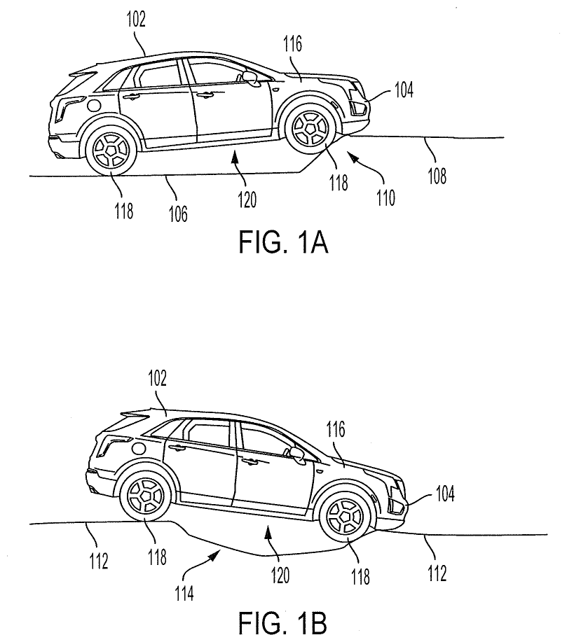

FIGS. 1A-1B illustrate a vehicle 102 having a vehicle carriage 116 and wheels 118. The vehicle carriage 116 includes an undercarriage 120 located on a bottom surface of the vehicle 102 and a bumper 104. The bumper 104 may be a front bumper or a rear bumper.

FIG. 1A illustrates the vehicle 102 scraping the bumper 104 of the vehicle carriage 116 on an inclined surface 110. The inclined surface may be a ramp to a driveway or a parking lot, for example. The vehicle 102 may be travelling along the road 106 and may traverse the inclined surface 110 to reach a second surface 108. If the vehicle 102 drives too quickly and/or does not have the requisite ground clearance, the vehicle carriage 116 may make contact with the inclined surface 110 and/or the second surface 108. In particular, the bumper 104 and/or the undercarriage 120 may make contact with the inclined surface 110 and/or the second surface 108.

FIG. 1B illustrates the vehicle 102 scaping the bumper 104 of the vehicle carriage 116 on a road 112 due to a dip 114. The dip 114 may be purposely located by a municipality or owner of a parking lot to slow down vehicles which may be driving excessively quickly. The dip 114 may be formed over time as water and/or air erodes the road 112. If the vehicle 102 drives too quickly and/or does not have the requisite ground clearance, the vehicle carriage 116 may make contact with the road 112 as the vehicle 102 is driving over the dip 114. In particular, the bumper 104 and/or the undercarriage 120 may make contact with the road 112 as the vehicle 102 is driving over the dip 114.

In many situations, a driver of vehicle 102 may not be able to judge the steepness of an incline or the depth of a dip in sufficient time to slow down to avoid scraping the vehicle carriage 116. However, the driver of the vehicle 102 may be able to avoid scraping the vehicle carriage 116 if the driver is made aware of the locations where scraping is possible in advance of reaching those locations.

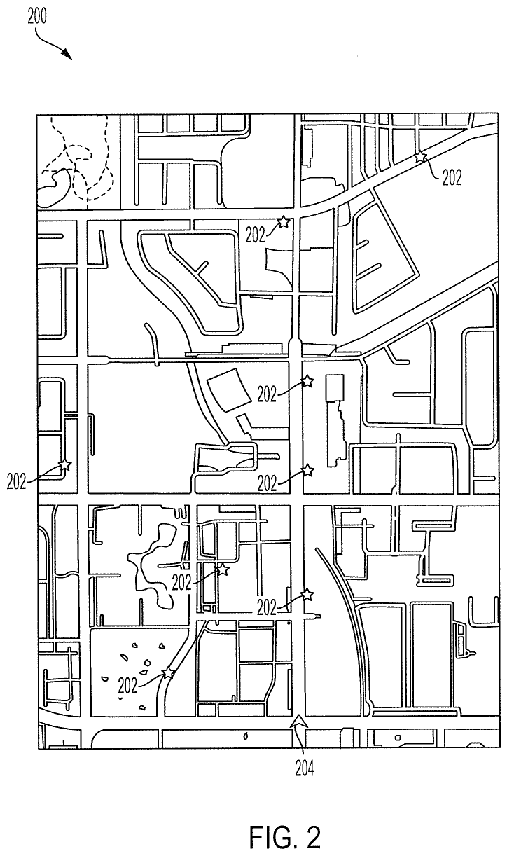

FIG. 2 illustrates a map 200 showing scraping locations 202. Scraping locations 202 are locations where a dip or steeply inclined curb or any other road feature exists that may cause a vehicle to scrape the vehicle carriage on the road feature.

When the driver is made aware of an upcoming scraping location 202, the driver may drive in a slower or different manner in order to prevent or reduce the scraping of the vehicle carriage encountered by the vehicle. For example, when a driver approaching a dip is aware that the dip may cause the vehicle carriage to be scraped on the ground, the driver may engage the brakes to cause the vehicle to traverse the dip very slowly. When the dip is traversed slowly, the vehicle carriage may not be scraped, as the suspension is allowed to slowly adjust to the reduced road height in the dip.

A vehicle 204 may be aware of all of the scraping locations in an area around the vehicle 204. The vehicle 204 may provide the driver of the vehicle with a warning when a scraping location is being approached. The vehicle 204 may also automatically navigate around the scraping locations 202 to avoid the scraping locations 202.

The vehicle 204 may also detect scraping locations using vehicle sensors, and the vehicle may report detected scraping locations to a remote data server so that other vehicles may be made aware of the scraping locations. The severity of scraping locations may vary, and some vehicles may not encounter a scraping of the vehicle carriage when traversing some scraping locations due to vehicle characteristics, such as ground clearance. Thus, each scraping location 202 may be associated with vehicle specifications associated with vehicles which may experience scraping when traversing the scraping location. Various vehicles may have different scraping locations 202 shown on the same map based on the specifications of the respective vehicles.

While a map of roads and streets is shown in FIG. 2, the scraping locations 202 may be mapped in smaller areas, such as a parking lot. Poles in parking lots and poles in drive-thru lanes of fast food restaurants may also be identified if vehicles commonly scrape their vehicle carriages at those locations.

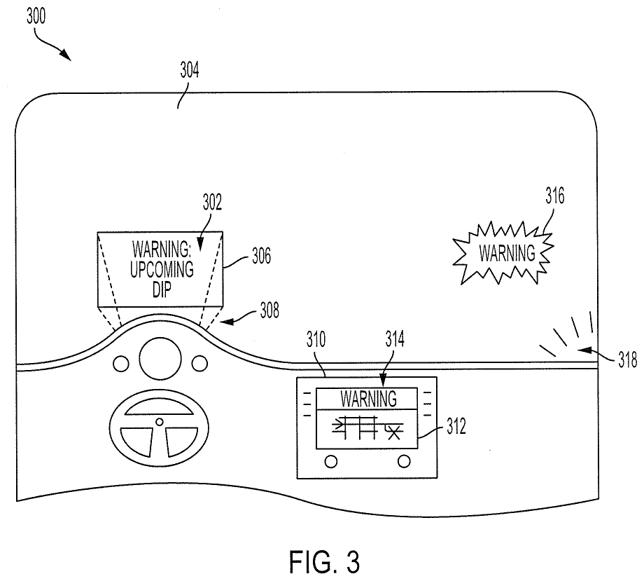

FIG. 3 illustrates example user interfaces presenting warning notifications to the driver of the vehicle 300. The vehicle 300 may include a heads-up display (HUD) image 306 that is projected from a HUD unit 308 onto a front windshield 304 of the vehicle 300. The HUD image 306 may include warning information 302 indicating that the vehicle 300 is approaching a scraping location. The warning information 302 may include further details of the scraping location, such as a distance the scraping location is away from the vehicle 300. The warning information 302 may also include tips or techniques to mitigate the risk of the vehicle carriage scraping, such as “Please drive below 7 miles per hour when traversing the upcoming dip.” The warning information 302 may also include statistics of vehicles that have been scraped at the upcoming scraping location. For example, the warning information 302 may state “Of the past 100 vehicles similar to yours that approached this scraping location, 85 of them scraped their vehicle carriage.”

The vehicle 300 may also have an infotainment unit 310, which has an input/output device 312 (e.g., a touchscreen display). The input/output device 312 may also display warning information 314 similar to warning information 302. The infotainment unit 310 may also display a map with turn-by-turn navigation directions to a destination. The navigation directions may automatically avoid roads or locations having scraping locations. The map displayed by the input/output device 312 of the infotainment unit 310 may also show the scraping locations on a map, similar to FIG. 2. In some embodiments, a display of a dip or curb or other object that may cause damage to the vehicle carriage may be identified or highlighted to show the driver what to avoid.

The vehicle 300 may also have one or more speakers 318 configured to produce sounds. The speakers 318 may audibly present warning information 316 similar to warning information 302 for the driver to hear.

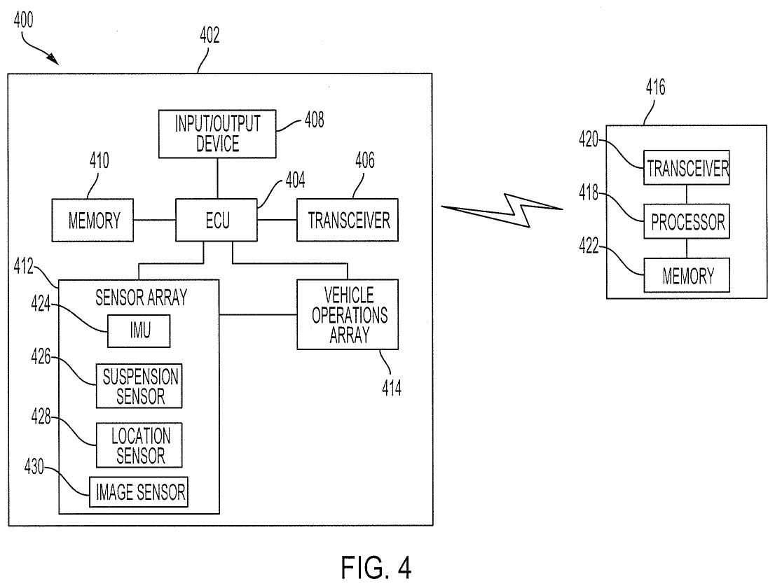

FIG. 4 illustrates a block diagram of the system 400. The system 400 includes a vehicle 402 and a remote data server 416.

The vehicle 402 may have an automatic or manual transmission. The vehicle 402 is a conveyance capable of transporting a person, an object, or a permanently or temporarily affixed apparatus. The vehicle 402 may be a self-propelled wheeled conveyance, such as a car, a sports utility vehicle, a truck, a bus, a van or other motor or battery driven vehicle. For example, the vehicle 402 may be an electric vehicle, a hybrid vehicle, a plug-in hybrid vehicle, a fuel cell vehicle, or any other type of vehicle that includes a motor/generator. Other examples of vehicles include bicycles, trains, planes, or boats, and any other form of conveyance that is capable of transportation. The vehicle 402 may be a semi-autonomous vehicle or an autonomous vehicle. That is, the vehicle 402 may be self-maneuvering and navigate without human input. An autonomous vehicle may use one or more sensors and/or a navigation unit to drive autonomously.

The vehicle 402 includes an electronic control unit (ECU) 404, an input/output device 408, a transceiver 406, a memory 410, a sensor array 412, and a vehicle operations array 414.

Each ECU 404 may be one or more ECUs, appropriately programmed, to control one or more operations of the vehicle. The one or more ECUs 404 may be implemented as a single ECU or in multiple ECUs. The ECU 404 may be electrically coupled to some or all of the components of the vehicle. In some embodiments, the ECU 404 is a central ECU configured to control one or more operations of the entire vehicle. In some embodiments, the ECU 404 is multiple ECUs located within the vehicle and each configured to control one or more local operations of the vehicle. In some embodiments, the ECU 404 is one or more ping locations and store the location data and vehicle telemetry dans stored in a non-transitory memory 410.

The vehicle 402 and one or more other vehicles similar to vehicle 402 may be coupled to a network. The network, such as a local area network (LAN), a wide area network (WAN), a cellular network, a digital short-range communication (DSRC), the Internet, or a combination thereof, connects the vehicle 402 to a remote data server 416.

The transceiver 406 may include a communication port or channel, such as one or more of a Wi-Fi unit, a Bluetooth® unit, a Radio Frequency Identification (RFID) tag or reader, a DSRC unit, or a cellular network unit for accessing a cellular network (such as 3G, 4G, or 5G). The transceiver 406 may transmit data to and receive data from devices and systems not directly connected to the vehicle. For example, the ECU 404 may communicate with the remote data server 416. Furthermore, the transceiver 406 may access the network, to which the remote data server 416 is also connected. The vehicle 402 may communicate with other vehicles directly or via a network.

The sensor array 412 includes a plurality of vehicle sensors each configured to detect vehicle telemetry data. The sensor array 412 may include an inertial measurement unit (IMU) 424 configured to detect acceleration, deceleration, roll, pitch, and yaw of a vehicle. When the vehicle 402 makes contact with a surface (e.g., a curb or the road), the IMU data detected by the IMU 424 may reflect that a sharp contact with an object was made, and the IMU data may be communicated to the remote data server 416 along with the location when the contact was detected. The IMU data may also reflect a sharp increase in vertical acceleration (e.g., a drop), experienced by the vehicle 402 driving over a dip. This IMU data and the location may be communicated to the remote data server 416.

The sensor array 412 may include a suspension sensor 426 configured to detect suspension data. The suspension data may indicate a compression of the suspension of the vehicle and/or a ground clearance of the vehicle 402. When the suspension data indicates that there is an uneven compression of the suspension of the vehicle, the system may determine that the vehicle is traversing a dip or an inclined curb. The suspension data may be cross-referenced with the IMU data to determine whether the vehicle carriage has been scraped due to a road feature, such as a curb or dip.

The sensor array 412 may include an image sensor 430 configured to detect image data. The image sensor 430 may be a camera or a video camera, for example. The ECU 404 may be able to detect or confirm the scraping location based on the detected image data. The ECU 404 may use machine learning techniques to identify road features commonly associated with the scraping of a carriage of a vehicle.

The sensor array 412 may include a location senor 428 configured to detect location data associated with the vehicle 402. The location sensor may be a GPS unit or any other global location detection device. The ECU 404 may use the location data along with the map data stored in the memory 410 to determine a location of the vehicle. In other embodiments, the location sensor 428 has access to the map data and may determine the location of the vehicle and provide the location of the vehicle to the ECU 404.

The location data may be used to determine where the vehicle encountered a scrape to the vehicle carriage. The location data associated with the scraping location may be communicated to the remote data server 416. When a threshold number or percentage of vehicles detect the same scraping location, the system may provide warnings to vehicles approaching the scraping location.

The memory 410 is connected to the ECU 404 and may be connected to any other component of the vehicle. The memory 410 is configured to store any data described herein, such as vehicle data, map data, location data, suspension data, IMU data, scraping location data and any data received from the remote data server 416 via the transceiver 406. The vehicle data associated with the vehicle 402 may indicate the features and capabilities of the vehicle 402, and may include any modifications or equipment associated with the vehicle 402. For example, if the vehicle suspension is altered or thicker tires are installed on the vehicle 402, the vehicle data may be accordingly updated. The vehicle data may be updated via the input/output device 408 or may be automatically detected by sensors in the sensor array 412. The warnings regarding upcoming scraping locations may be provided based on the vehicle data. For example, if a particular scraping location is a concern for vehicles that have less than 6 inches of ground clearance, but the vehicle 402 has 10 inches of ground clearance, the warning notifications regarding the upcoming scraping location may not be provided, as there is low risk of scraping the vehicle carriage. The vehicle data may also include temporary conditions which may affect whether a vehicle will scrape at a scraping location. For example, the vehicle data may include a detected weight of cargo being carried by the vehicle. If a vehicle is carrying an abnormally large amount of cargo and the vehicle scrapes its vehicle carriage, another vehicle, even the same make and model, may not scrape its vehicle carriage if it is not carrying any cargo.

The input/output device 408 may be a touchscreen display or a display screen and an input device, such as a keyboard, microphone, or buttons. The input/output device 408 may be a touchscreen of an infotainment unit of the vehicle 402, a heads-up display, or a combination of a display screen of the infotainment unit and one or more buttons or knobs used to interact with the infotainment unit. The ECU 404 may be configured to render a graphical user interface to facilitate displaying of notifications and warnings as described herein.

The vehicle operations array 414 is connected to the ECU 404 and the sensor array 412. The vehicle operations array 414 may include a suspension system, for example. The ECU 404 may communicate an indication to the vehicle operations array 414 to adjust one or more features of the vehicle 402 in anticipation of an upcoming scraping location. For example, the ECU 404 may automatically instruct the suspension system to raise the ground clearance from 7 inches to 10 inches when a scraping location is upcoming. The ECU 404 may automatically instruct the suspension system to lower the ground clearance back to 7 inches when the scraping location has been passed.

The remote data server 416 includes a processor 418, a memory 422, and a transceiver 420. The processor 418 of the remote data server 416 may be one or more computer processors configured to execute instructions stored in non-transitory memory 422. The memory 422 may also store the vehicle telemetry data, the vehicle data, and the scraping location data received from the vehicle 402 and many other vehicles similar to vehicle 402.

In some embodiments, the processor 418 of the remote data server 416 determines scraping location data indicating scraping locations based on the vehicle telemetry data and vehicle data received from a plurality of vehicles. The determined scraping location data is communicated to the vehicle 402, which stores the scraping location data in memory 410 and when the vehicle 402 approaches a scraping location identified by the scraping location data, the vehicle 402 may produce a notification, as shown in FIG. 3.

The processor 418 of the remote data server 416 may collect all of the vehicle data and vehicle telemetry data from many vehicles (e.g., hundreds, thousands, or millions of vehicles) to determine the scraping location data. The scraping location data determined by the remote data server 416 may be periodically updated over time, as road conditions may change. The scraping location data may be updated every day, every month, every year, for example.

The ECU 404 of the vehicle 402 is configured to determine navigation directions from a current location of the vehicle to a destination received from the user via the input/output device 408. The ECU 404 of the vehicle 402 may automatically avoid the scraping locations when determining the navigation directions. In some embodiments, the ECU 404 of the vehicle 402 may instruct the input/output device 408 to provide a risk of damage to the vehicle or unpleasant ride conditions when the chosen navigation directions include traversing over the scraping locations.

While only one remote data server 416 is shown, any number of remote data servers in communication with each other may be used.

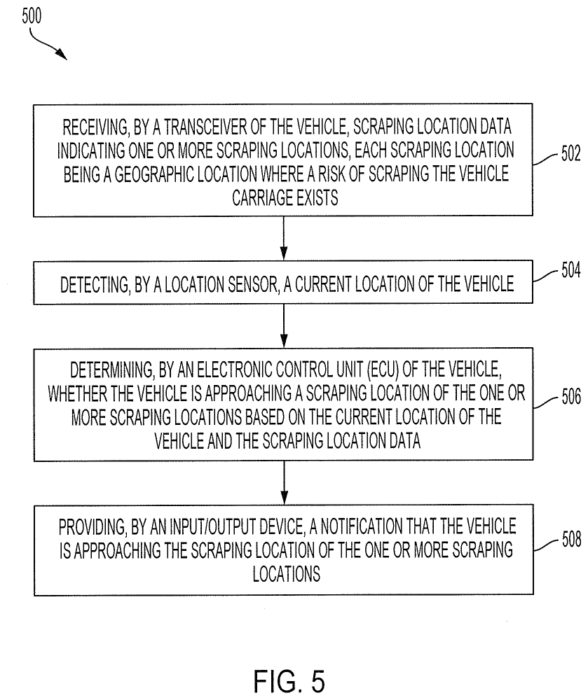

FIG. 5 illustrates a process 500 performed by the system described herein.

A transceiver (e.g., transceiver 406) of the vehicle (e.g., vehicle 402) receives scraping location data indicating one or more scraping locations (step 502). Each scraping location is a geographic location where a risk of scraping the vehicle carriage exists. The risk may be determined by other vehicles having previously scraped their vehicle carriages at the scraping location. In some embodiments, a risk exists if at least a threshold number of vehicles have scraped their vehicle carriage at the location. In some embodiments, a risk exists if at least a threshold percentage of vehicles that traverse the location have scraped their vehicle carriage. The vehicle receives the scraping location data from a remote data server (e.g., remote data server 416) via a transceiver (e.g., transceiver 420) of the remote data server. In some embodiments, the vehicle receives the scraping location data from another vehicle.

A location sensor (e.g., location sensor 428) of the vehicle detects a current location of the vehicle (step 504). An electronic control unit (ECU) (e.g., ECU 404) of the vehicle determines whether the vehicle is approaching a scraping location of the one or more scraping locations based on the current location of the vehicle and the scraping location data (step 506). The scraping location data may be a list of geographic coordinates of the scraping locations and the current location of the vehicle may also be in the form of geographic coordinates.

An input/output device (e.g., input/output device 408) provides a notification that the vehicle is approaching the scraping location (step 508). The input/output device may provide an audible notification or a visual notification, as described herein.

In some embodiments, the ECU is configured to determine navigation directions to a destination, and the ECU may automatically avoid the scraping locations in the navigation directions. The ECU may also be configured to instruct a vehicle operations array (e.g., vehicle operations array 414) to adjust one or more vehicle settings in anticipation of traversing a scraping location. The vehicle settings may be adjusted to allow the vehicle to safely traverse the scraping location or the vehicle settings may be adjusted to reduce possible scraping damage to the vehicle carriage when the vehicle traverses the scraping location. When the vehicle is an autonomous vehicle, the vehicle may automatically avoid or slow down when encountering the scraping locations, as described herein.

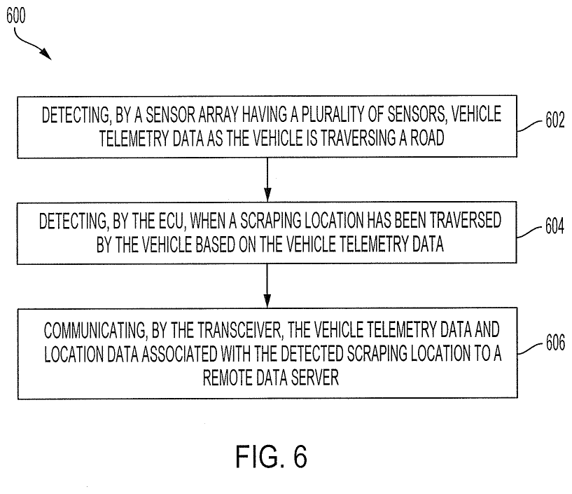

FIG. 6 illustrates a process 600 performed by the system described herein.

A sensor array (e.g., sensor array 412) of a vehicle (e.g., vehicle 402) detects vehicle telemetry data as the vehicle is traversing a road (step 602). The sensor array may include an inertial measurement unit (IMU) (e.g., IMU 424), a suspension sensor (e.g., suspension sensor 426), a location sensor (e.g., location sensor 428), or an image sensor (e.g., image sensor 430).

The ECU (e.g., ECU 404) detects when a scraping location has been traversed by the vehicle based on the vehicle telemetry data (step 604). Traversing a scraping location may result in one or more of the sensors of the sensor array exceeding a threshold value of sensor data. For example, the IMU data of downward acceleration may exceed a threshold value indicating a steep drop and the IMU data may also indicate a sharp stop to the downward acceleration. Thus, the ECU may detect a scraping location has been traversed based on the IMU data detected.

A transceiver (e.g., transceiver 406) of the vehicle communicates the vehicle telemetry data and the location data of the detected scraping location to a remote data server (e.g., remote data server 416) (step 606). A transceiver (e.g., transceiver 420) of the remote data server may receive the vehicle telemetry data and the location data.

The remote data server may store the received telemetry data and the location data of the detected scraping location in a memory (e.g., memory 422). The remote data server may compile numerous detected scraping locations from numerous vehicles and provide the detected scraping locations as the scraping location data, as described in FIG. 5.

In some embodiments, the processor 418 of the remote data server includes a given scraping location in the scraping location data to be provided to vehicles when the given scraping location is detected by a threshold number of vehicles or by a threshold percentage of vehicles that traverse the location.

The scraping locations may have associated vehicle specifications describing vehicles which may be affected by the scraping location. For example, a first scraping location may be associated with vehicles that have under 6 inches of ground clearance, and a second scraping location may be associated with vehicles that have under 4 inches of ground clearance. A first vehicle having 3 inches of ground clearance may receive warning notifications as the first vehicle approaches both the first scraping location and the second scraping location. A second vehicle having 5 inches of ground clearance may receive a warning notification when the second vehicle approaches the first scraping location, but not when the second vehicle approaches the second scraping location.

In order for the processor (e.g., processor 418) of the remote data server to associate vehicle specifications with scraping locations, the vehicles also communicate vehicle data to the remote data server along with vehicle telemetry data and the detected location of the scraping location. The vehicle data provides features (permanent and temporary) associated with the vehicle when the vehicle detected the scraping location. The processor of the remote data server may determine features or characteristics that the vehicles which detected a scraping location have in common, and these common features may be associated with the scraping location. The compiled scraping location data may be provided or sold to a municipality or other third party, who may use the scraping location data in taking action, for example, repairing dips that are potholes or designing streets and cities.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for identifying geographic locations where a vehicle carriage of a vehicle may be scraped, the system comprising:
a transceiver of the vehicle configured to receive scraping location data indicating one or more scraping locations, each scraping location being a geographic location where a risk of scraping the vehicle carriage exists;
a location sensor configured to detect a current location of the vehicle;
an electronic control unit (ECU) of the vehicle configured to determine whether the vehicle is approaching a scraping location of the one or more scraping locations based on the current location of the vehicle and the scraping location data; and
an input/output device configured to provide a notification that the vehicle is approaching the scraping location of the one or more scraping locations.

2. The system of claim 1, further comprising a sensor array having a plurality of sensors configured to detect vehicle telemetry data as the vehicle is traversing a road and configured to detect when a scraping location has been traversed by the vehicle, and wherein the transceiver is further configured to communicate the vehicle telemetry data and location data associated with the detected scraping location to a remote data server.

3. The system of claim 2, wherein the remote data server is configured to receive location data and vehicle telemetry data from a plurality of vehicles that have detected scraping locations and store the location data and vehicle telemetry data in memory.

4. The system of claim 2, wherein the plurality of sensors include at least one of an inertial measurement unit, a suspension sensor, or an image sensor.

5. The system of claim 2, wherein the transceiver is further configured to communicate vehicle data including features of the vehicle to the remote data server, and wherein a processor of the remote data server is configured to determine, for each scraping location, common vehicle features of vehicles that detected the scraping location.

6. The system of claim 1, wherein the ECU is further configured to avoid the scraping location when determining navigation directions to a destination.

7. The system of claim 1, further comprising a vehicle operations array configured to adjust one or more components of the vehicle, and wherein the ECU automatically instructs the vehicle operations array to adjust one or more components of the vehicle before the vehicle traverses a scraping location.

8. The system of claim 1, wherein the input/output device is further configured to display a map of the one or more scraping locations.

9. A vehicle comprising:
a vehicle carriage and wheels;
a transceiver configured to receive scraping location data indicating one or more scraping locations, each scraping location being a geographic location where a risk of scraping the vehicle carriage exists;
a location sensor configured to detect a current location;
an electronic control unit (ECU) configured to determine whether a scraping location of the one or more scraping locations is being approached based on the current location and the scraping location data; and
an input/output device configured to provide a notification that the vehicle is approaching the scraping location of the one or more scraping locations.

10. The vehicle of claim 9, further comprising a sensor array having a plurality of sensors configured to detect vehicle telemetry data as the vehicle is traversing a road and configured to detect when a scraping location has been traversed by the vehicle, and wherein the transceiver is further configured to communicate the vehicle telemetry data and location data associated with the detected scraping location to a remote data server.

11. The vehicle of claim 10, wherein the remote data server is configured to receive location data and vehicle telemetry data from a plurality of vehicles that have detected scraping locations and store the location data and vehicle telemetry data in memory.

12. The vehicle of claim 10, wherein the plurality of sensors include at least one of an inertial measurement unit, a suspension sensor, or an image sensor.

13. The vehicle of claim 10, wherein the transceiver is further configured to communicate vehicle data including features of the vehicle to the remote data server, and wherein a processor of the remote data server is configured to determine, for each scraping location, common vehicle features of vehicles that detected the scraping location.

14. The vehicle of claim 9, wherein the ECU is further configured to avoid the scraping location when determining navigation directions to a destination.

15. The vehicle of claim 9, further comprising a vehicle operations array configured to adjust one or more components of the vehicle, and wherein the ECU automatically instructs the vehicle operations array to adjust one or more components of the vehicle before the vehicle traverses a scraping location.

16. The vehicle of claim 9, wherein the input/output device is further configured to display a map of the one or more scraping locations.

17. A method for identifying geographic locations where a vehicle carriage of a vehicle may be scraped, the method comprising:
receiving, by a transceiver of the vehicle, scraping location data indicating one or more scraping locations, each scraping location being a geographic location where a risk of scraping the vehicle carriage exists;
detecting, by a location sensor, a current location of the vehicle;
determining, by an electronic control unit (ECU) of the vehicle, whether the vehicle is approaching a scraping location of the one or more scraping locations based on the current location of the vehicle and the scraping location data; and
providing, by an input/output device, a notification that the vehicle is approaching the scraping location of the one or more scraping locations.

18. The method of claim 17, further comprising:
detecting, by a sensor array having a plurality of sensors, vehicle telemetry data as the vehicle is traversing a road;
detecting, by the ECU, when a scraping location has been traversed by the vehicle based on the vehicle telemetry data; and
communicating, by the transceiver, the vehicle telemetry data and location data associated with the detected scraping location to a remote data server.

19. The method of claim 18, further comprising:
communicating, by the transceiver, vehicle data including features of the vehicle to the remote data server; and
determining, by a processor of the remote data server, for each scraping location, common vehicle features of vehicles that detected the scraping location.

20. The method of claim 17, further comprising automatically adjusting, by the ECU using a vehicle operations array, one or more components of the vehicle before the vehicle traverses a scraping location.
